(19) United States
(12) Patent Application Publication
(10) Pub. No.: US 2026/0318145 A1
(43) Pub. Date: Oct. 15, 2026

(54) SECURE SYSTEM FOR CONTROLLING THE OPENING AND CLOSING OF A MOTOR VEHICLE DOOR

(71) Applicant: SCHAEFFLER TECHNOLOGIES AG & CO. KG, Herzogenaurach (DE)

(72) Inventors: Alain DE LA TORRE, Toulouse (FR); Wladia WASZAK, Toulouse (FR)

(21) Appl. No.: 19/112,030

(22) PCT Filed: Nov. 7, 2023
(86) PCT No.: PCT/EP2023/081051

§ 371 Date: Mar. 14, 2025

(30) Foreign Application Priority Data
Nov. 14, 2022 (FR) FR2211803

(51) Int. Cl. E05F 15/73; H04W 4/48

(52) U.S. Cl. CPC E05F 15/73; H04W 4/48; E05Y 2400/664; E05Y 2400/858; E05Y 2900/548

(57) ABSTRACT

A system (10) for controlling the opening and closing of an opening element (11) of a motor vehicle (1), comprising:
a transmission and reception module for transmitting a first radio-frequency signal transmitted to a first detection area (ZD1) and a second radio-frequency signal transmitted to a second detection area (ZD2), and to receive a first received radio-frequency signal and a second received radio-frequency signal;
a first gesture detection module connected to the transmission and reception module (110) and configured to detect at least one predetermined gesture performed in the first detection area (ZD1);
a second gesture detection module connected to the transmission and reception module (110) and configured to detect any gesture performed in the second detection area (ZD2); and
an opening element control module intended, when the opening element is in the open position, to issue a command for closing the opening element when a predetermined closing gesture is detected in the first detection area (ZD1), unless a gesture has been detected in the second detection area (ZD2).

### TECHNICAL FIELD

The invention relates to the field of motor vehicles and more specifically to a system for controlling the opening and closing of an opening element of the motor vehicle.

The opening element is advantageously a tailgate or a door of a rear trunk. It also can be any other opening element in a motor vehicle, for example, a side door.

### PRIOR ART

Systems for controlling the opening and closing of an opening element of a motor vehicle are known in the prior art, allowing a user located outside the vehicle to remotely control the opening or closing of the opening element.

Such systems are based, for example, on detecting a predetermined gesture, performed by a user located in a predetermined area outside the vehicle.

For example, the user may wish to open, or respectively close, the tailgate of the motor vehicle. To this end, they perform a swinging movement with their foot, so that the foot approaches and then moves away from the vehicle. This movement forms a predetermined gesture, which is detected by Doppler detection and using a radio-frequency signal that is transmitted and then reflected on the moving foot. It is possible to have a respective predetermined gesture for controlling the opening, respectively the closing, of the opening element. As a variant, the same gesture is associated with opening and closing, with either command being selected as a function of a current position of the opening element.

For safety reasons, the automatic closure of the opening element may need to be prevented, despite the detection of the associated predetermined gesture.

This is particularly the case when the user performs tasks inside the rear trunk, for example, handling luggage, shopping bags or any other utensil located in the rear trunk. On these occasions, the user may accidentally and unintentionally perform the predetermined closing gesture. The opening element then needs to be prevented from closing on the user.

An aim of the present invention is to propose a system for controlling the opening and closing of an opening element of a motor vehicle providing improved safety.

In particular, an aim of the present invention is to prevent the opening element from closing on a user who would, accidentally and unintentionally, perform a predetermined gesture associated with a command for remotely closing this opening element.

### DISCLOSURE OF THE INVENTION

This aim is achieved with a system for controlling the opening and closing of an opening element of a motor vehicle, comprising:
a transmission and reception module, configured to transmit a first radio-frequency signal, called first transmitted radio-frequency signal, to a first detection area located outside the motor vehicle during use, and to receive a first radio-frequency signal, called first received radio-frequency signal, originating from a reflection of the first transmitted radio-frequency signal;
a first gesture detection module, configured to receive data originating from the transmission and reception module, and to implement, based on said data, the detection of at least one predetermined gesture performed in the first detection area; and
an opening element control module, configured to receive data originating from the first gesture detection module and to issue a command for opening, respectively for closing, the opening element.

According to the invention, the control system has the following specific features:
the transmission and reception module is configured to also transmit, when the opening element is in the open position, a second radio-frequency signal, called second transmitted radio-frequency signal, to a second detection area separate from the first detection area, and to receive a second radio-frequency signal, called second received radio-frequency signal, originating from a reflection of the second transmitted radio-frequency signal;
the system further comprises a second gesture detection module, configured to receive data (when said data exists) originating from the transmission and reception module, and to implement, based on said data, the detection of any gesture performed in the second detection area; and
the opening element control module is configured to also receive (when said data exists) data originating from the second gesture detection module, and to:
i/ issue the command for closing the opening element, when the first gesture detection module has detected a predetermined closing gesture in the first detection area, while the second detection module has detected the absence of a gesture in the second detection area; and
ii/ not issue the command for closing the opening element, when the first gesture detection module has detected the predetermined closing gesture in the first detection area, while the second detection module has detected any gesture performed in the second detection area.

In other words, the command for closing the opening element is issued when the predetermined gesture is detected in the first detection area, unless a gesture has been detected in the second detection area.

Throughout this document, the terms “above”, “below”, “under”, “over”, etc., relate to the gravitational axis oriented from the ground surface to the sky, and to a position of the vehicle resting on a horizontal ground surface with its four wheels in contact with the ground surface. A horizontal ground surface extends in a plane orthogonal to the gravitational axis.

Throughout this document, the terms “in front of”, “behind”, “front”, “rear”, etc., relate to the longitudinal axis of the vehicle, oriented in the same way as the direction of forward travel of the vehicle (wheels straight).

According to the invention, the transmission and reception module thus ensures not only the transmission and reception of a radio-frequency signal in the first detection area, but also ensures the transmission and reception of a radio-frequency signal in the second detection area.

The first detection area corresponds, during use, to the location intended for the user to perform the predetermined gesture for commanding the closure of the opening element.

The radio-frequency signal transmitted and then reflected in the first detection area thus allows the predetermined gesture for commanding the closure of the opening element that is performed by a user to be detected (first gesture detection module) when it occurs.

For example, the opening element is an opening element of a rear trunk, and the first detection area extends behind and/or under the vehicle.

The second detection area is separate from the first detection area. During use, it is located at a point where an activity is to be detected, so as to prevent the opening element from closing if an activity occurs at this location. Advantageously, during use, the second detection area is at least partly located inside the vehicle. Additionally or as a variant, the second detection area is at least partly located on the path of the opening element when closing the opening element.

The radio-frequency signal transmitted and then reflected in the second detection area allows this activity to be detected (second gesture detection module).

For example, the opening element is an opening element of a rear trunk, and the second detection area extends inside and/or over the rear trunk.

According to the invention, the opening element control module is configured to issue a command for closing the opening element when the predetermined gesture has been detected in the first detection area, unless an activity has been detected in the second detection area.

This activity corresponds to any movement or gesture detected using the second gesture detection module.

Thus, it is possible to prevent the trunk from closing when the circumstances make such an operation dangerous.

For example, the closure of the trunk is prevented when an activity is detected in and/or over the rear trunk, even if the predetermined gesture was detected at the expected location. This notably corresponds to a situation in which a user performs this predetermined gesture accidentally and unintentionally, while they are performing tasks in and/or in the immediate vicinity of the rear trunk (unloading or loading luggage, shopping bags, for example).

The invention thus provides a system for controlling the opening and closing of an opening element of a motor vehicle, providing improved safety.

An obvious solution for addressing this technical problem would have involved providing manual blocking of the closure of the opening element, via a mechanical interface, such as a push button allowing the user to block any possibility of the opening element closing.

The solution proposed herein is much simpler to use, since no deliberate action of the user is required to ensure that the opening element is closed safely.

Another solution for addressing this technical problem could have involved working on the algorithm for detecting the predetermined gesture, in order to even better discriminate an intentionally performed gesture from an accidentally performed gesture.

The advantage of the solution proposed herein is that it does not involve modifying the pre-existing algorithms for detecting the predetermined gesture.

Finally, the invention offers the advantage of combining numerous elements together, which allows, on the one hand, the detection of the predetermined gesture and the control of the opening and closing of the opening element to be carried out based on this gesture detection, and which also allows, on the other hand, the detection of activity in the second area and the safe closure of the opening element to be carried out based on this detection of activity.

Thus, the system according to the invention is highly compact.

According to the invention, the second transmitted radio-frequency signal is at least transmitted when the opening element is in the open position. It cannot be transmitted when the opening element is in the closed position, in order to optimize power consumption. As a variant, it is also transmitted when the opening element is in the closed position, for minimal complexity.

Advantageously, the system according to the invention can store information relating to a current position of the opening element, in order to determine whether the opening element is in the open or closed position. This information can originate from a position sensor, or from a log of opening and closing movements of the opening element.

Preferably, the transmission and reception module comprises an electronic oscillator, configured to generate a source electrical signal, and the transmission and reception module is configured to use said source electrical signal to form both the first transmitted radio-frequency signal and the second transmitted radio-frequency signal.

The transmission and reception module can further comprise:
at least one first antenna, configured to receive at least a portion of the source electrical signal as input, and to transmit the first transmitted radio-frequency signal in response; and
at least one second antenna, configured to receive at least a portion of the source electrical signal as input when the opening element is in the open position, and to transmit the second transmitted radio-frequency signal in response.

If appropriate, the transmission and reception module can comprise a switching module for distributing the source electrical signal over various channels depending on whether the opening element is in the open or closed position. Thus, the arrival of the electrical signal on the second antenna is blocked when the opening element is in the closed position. By contrast, when the opening element is in the open position, the second antenna receives a portion of the source electrical signal.

The transmission and reception module can comprise at least one first mixer, configured to carry out mixing between an electrical signal at the frequency of the second transmitted radio-frequency signal and an electrical signal formed by the second received radio-frequency signal, with the transmission and reception module being configured to provide the first gesture detection module with data resulting from this mixing.

Similarly, the transmission and reception module can comprise at least one second mixer, configured to carry out mixing between an electrical signal at the frequency of the second transmitted radio-frequency signal and an electrical signal formed by the second received radio-frequency signal, with the transmission and reception module being configured to provide the second gesture detection module with data resulting from this mixing.

The invention also relates to a motor vehicle comprising at least one opening element able to be closed or opened upon receiving a command for closing, respectively opening, the opening element, with the vehicle further comprising a control system according to the invention.

Preferably, said opening element is an opening element of a rear trunk, and:
the first detection area extends under and/or behind the motor vehicle; and
the second detection area extends into and/or over said rear trunk.

The invention also relates to a method for controlling the closing of an opening element of a motor vehicle, implemented within a motor vehicle comprising at least one opening element able to be closed upon receiving a closing command, and using a control system according to the invention, the method comprising the following steps, implemented when the opening element is in the open position:
a1/ transmitting the first transmitted radio-frequency signal to the first detection area located outside the vehicle; and
a2/ transmitting the second transmitted radio-frequency signal to the second detection area separate from the first detection area;
b1/ receiving the first received radio-frequency signal originating from the reflection of the first transmitted radio-frequency signal on a first target located in the first detection area; and
b2/ receiving, the second received radio-frequency signal, when said signal exists, originating from the reflection of the second transmitted radio-frequency signal on a second target located in the second detection area;
c1/ implementing first gesture detection, based on Doppler shift detection and using data originating from the first received radio-frequency signal; and
c2/ implementing, when a second received radio-frequency signal has been received in step b2/, second gesture detection, based on Doppler shift detection and using data originating from the second received radio-frequency signal; then
d/ issuing, when a predetermined closing gesture is detected in step c1/, and the absence of a gesture is detected in step c2/, the command for closing the opening element.

Preferably, said opening element is an opening element of a rear trunk, and:
the first detection area extends under and/or behind the motor vehicle; and
the second detection area extends into and/or over said rear trunk.

Advantageously, the first target is a foot of a user, and the second target is a portion of an upper limb or the torso or the head of said user.

### DESCRIPTION OF THE FIGURES

Further features and advantages of the invention will become more clearly apparent upon reading the following description. This description is purely illustrative and should be read with reference to the appended drawings, in which:

FIG. 1 schematically illustrates a vehicle fitted with a control system according to the invention;

FIG. 2 schematically illustrates a control system according to the invention;

FIG. 3 schematically illustrates an advantageous embodiment of a transmission and reception module in a control system according to the invention; and

FIG. 4 schematically illustrates a method according to the invention.

### DETAILED DESCRIPTION OF AT LEAST ONE EMBODIMENT

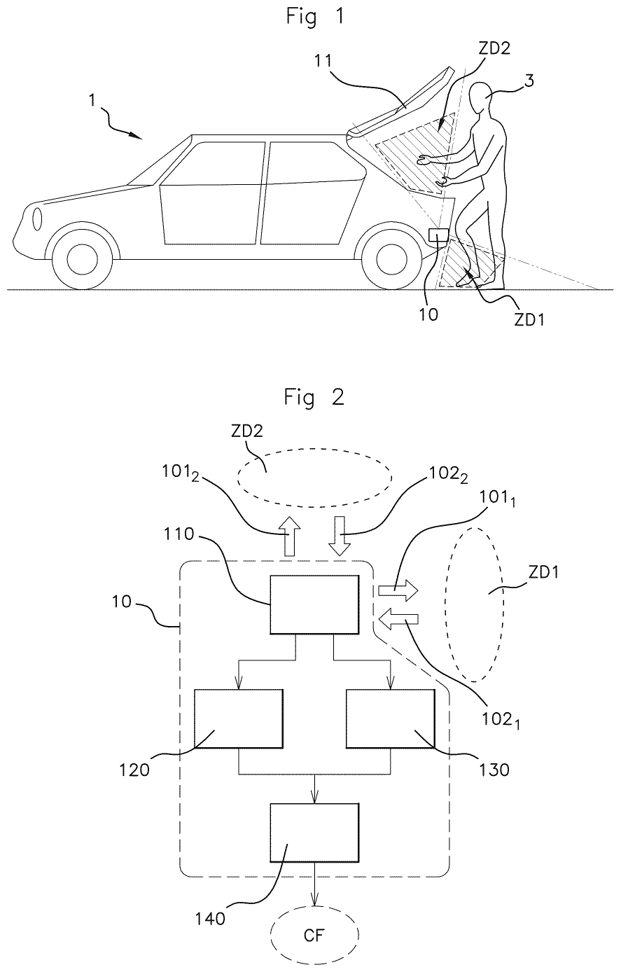

A motor vehicle 1 fitted with a control system 10 according to the invention will be initially described with reference to FIG. 1.

The motor vehicle 1 is fitted with at least one opening element 11 able to assume at least two positions, namely, a closed position, in which it obstructs an opening leading into the vehicle, and an open position, in which it grants access to said opening. In this case, but in a non-limiting manner, the opening element 11 is an opening element of a rear trunk, more specifically a tailgate.

The tailgate 11 can be closed, respectively opened, upon receiving a command for closing, respectively opening, the opening element, where said command is an electrical signal controlling an actuator.

The control system 10 is configured to control the opening, respectively the closing, of the tailgate 11. The control system 10 is described in greater detail hereafter, with reference to FIG. 2, and when necessary to FIG. 1.

The control system 10 comprises a radio-frequency signal transmission and reception module 110.

The transmission and reception module 110 in this case is configured to:
transmit a first transmitted radio-frequency signal 101₁ to a first detection area ZD1;
receive a first received radio-frequency signal 102₁ originating from the reflection of the first transmitted radio-frequency signal 101₁ on a target located in the first detection area ZD1;
transmit a second transmitted radio-frequency signal 101₂ to a second detection area ZD2; and
receive a second received radio-frequency signal 102₂ originating from the reflection of the second transmitted radio-frequency signal 101₂ on a target located in the second detection area ZD2.

The first detection area ZD1 is located outside the vehicle 1 during use. It is an area in which, during use, it is anticipated that a user 3 will perform a predetermined gesture when they wish to control the opening, respectively the closing, of the tailgate 11.

Hereafter, of particular interest is the command for closing the tailgate 11. Therefore, the tailgate 11 is initially in the open position. The aim of the invention is to safely close said tailgate.

In this case, but in a non-limiting manner, the first detection area ZD1 mainly extends behind the vehicle 1, as well as in a region located under the rear trunk.

Thus, the target located in the first detection area ZD1 is advantageously formed by the foot of the user 3 when they stand in line with the vehicle, on the rear trunk side. The predetermined gesture associated with the command to close the tailgate is, for example, a swinging movement of the foot for approaching and then moving away from the vehicle 1. This is normally referred to as a “kick”.

In practice, the first transmitted radio-frequency signal 101₁ is advantageously made up of two elementary radio-frequency signals, respectively transmitted toward the rear of the vehicle 1 and toward the underside of the vehicle 1. The first detection area ZD1 is then formed by combining two first elementary detection areas, each associated with a respective one of these two elementary radio-frequency signals.

The second detection area ZD2 is separate from the first detection area ZD1. Preferably, the second detection area ZD2 at least partly extends inside the vehicle 1. In this case, the second detection area ZD2 at least partly extends inside the rear trunk. In this case, but in a non-limiting manner, the second detection area ZD2 extends inside the rear trunk, as well as in an area over the rear trunk. As a variant, the second detection area ZD2 may only extend inside the vehicle, for example, only inside the rear trunk.

During use, the second detection area ZD2 corresponds to an area in which the upper body of the user is located, when they perform tasks in the rear trunk (for example, loading or unloading objects, luggage, or the like).

Thus, the target located in the second detection area ZD2 is advantageously formed by a portion of the upper body of the user 3 when the user performs tasks in the rear trunk. It is, for example, a portion of an upper limb, the torso, or the head of the user 3.

The second transmitted radio-frequency signal 101₂ is advantageously made up of a single signal, transmitted in the same direction. In the example illustrated herein, the second transmitted radio-frequency signal 101₂ is transmitted upward during use, toward the rear trunk.

Each of the radio-frequency signals 101₁, 101₂, 102₁, 102₂ is advantageously a frequency signal with a carrier frequency ranging between 3 kHz and 300 GHz. Preferably, the carrier frequency ranges between 1 GHz and 50 GHZ.

In practice, the transmission and reception module 110 comprises:
at least one radio-frequency antenna, for example, one or two antennas, for transmitting and receiving first radio-frequency signals 101₁ and 102₁;
another antenna, for transmitting and receiving second radio-frequency signals 101₂ and 102₂; and
an electrical oscillator, configured to generate an electrical signal intended to be converted into a radio-frequency signal by the antennas.

Advantageously, the transmission and reception module 110 is a radar chip, formed by an integrated circuit also accommodating pre-processing means for carrying out initial signal processing using the received radio-frequency signals 102₁ and 102₂. An advantageous embodiment of such a radar chip is described hereafter.

The data output from such a radar chip is:
first data I, Q, obtained by mixing an electrical signal at the frequency of the first transmitted radio-frequency signal 101₁ with an electrical signal corresponding to the first received radio-frequency signal 102₁; and
when available, second data I′, Q′, obtained by mixing an electrical signal at the frequency of the second transmitted radio-frequency signal 101₂ with an electrical signal corresponding to the second received radio-frequency signal 102₂.

The second data I′, Q′ only exists in the presence of a second received radio-frequency signal 102₂, i.e., when the second transmitted radio-frequency signal 101₂ exists (or even in the presence of a target in the second detection area ZD2).

The data I, Q (respectively I′, Q′) can be in the form of a matrix. The data “I” (respectively I′) corresponds to mixing, called “in phase” mixing, while the data “Q” (respectively Q′) corresponds to mixing, called “phase opposition” mixing, in which one of the signals is phase-shifted by 90°.

The control system 10 also comprises:
a first gesture detection module 120; and
a second gesture detection module 130.

The first gesture detection module 120 is configured to receive data related to the first transmitted radio-frequency signal 101₁ and to the first received radio-frequency signal 102₁ as input. Advantageously, the first gesture detection module 120 is configured to receive said first data I, Q as input.

The first gesture detection module 120 is configured to use this data in order to implement the detection of at least one predetermined gesture performed in the first detection area ZD1.

In particular, the first gesture detection module 120 is configured to determine, for a series of sampling instants, the value of a frequency shift related to the Doppler effect and to the current speed of movement of the target. A series of values is thus determined, together defining a gesture. The first gesture detection module 120 is also configured to compare the characteristics of the detected gesture with characteristics describing the at least one predetermined gesture, so as to detect the presence of said predetermined gesture. For example, a first predetermined gesture is associated with a request to open the opening element, and a second predetermined gesture, separate from the first gesture, is associated with a request to close the opening element. As a variant, a single predetermined gesture is associated with both a request to open and a request to close the opening element. Either request is then selected as a function of additional data, for example, data relating to a current position of the opening element (in this case the tailgate), and that is obtained, for example, using a position sensor or using a log of opening and closing movements.

The first gesture detection module 120 in practice is formed by a computer and at least one memory.

The second gesture detection module 130 is configured to receive data related to the second received radio-frequency signal 102₂ as input, as well as data related to the second transmitted radio-frequency signal 101₂, when said data exists. Advantageously, the second gesture detection module 130 is configured to receive said second data I′, Q′ as input, when said data exists.

The second gesture detection module 130 is configured to use this data in order to implement the detection of any gesture performed by a human operator in the second detection area ZD2. In other words, this involves determining the presence or the absence of a gesture performed by a human operator in the second detection area ZD2, irrespective of this gesture. In other words, this involves determining the presence or the absence of an activity in the second detection area ZD2.

Therefore, the performed gesture does not need to be accurately determined. It simply involves distinguishing between the absence of a gesture and the presence of a gesture. To this end, the second gesture detection module 130 can implement a simple comparison with a predetermined template.

Advantageously, the second gesture detection module 130 is configured to more specifically detect a gesture performed by a human operator, notably characterized by minimum and maximum speed (and therefore Doppler frequency) values. The strength of the second received radio-frequency signal, which depends on the material of the target, also can be taken into account.

This involves, for example, comparing data resulting from mixing between the second transmitted radio-frequency signal 101₂ and the second received radio-frequency signal 102₂ with a frequency template (or any other parameter representing a speed of the target) defining the normal frequency values (or of said parameter) in the presence of a gesture performed by a human operator in the second detection area ZD2.

Additionally or as a variant, this can involve comparing data resulting from mixing between the second transmitted radio-frequency signal 101₂ and the second received radio-frequency signal 102₂ with a phase template defining the normal phase-shift values in the presence of a gesture performed by a human operator in the second detection area ZD2.

Additionally or as a variant, this can involve comparing data resulting from mixing between the second transmitted radio-frequency signal 101₂ and the second received radio-frequency signal 102₂ with an amplitude template defining the normal signal amplitude values in the presence of a gesture performed by a human operator in the second detection area ZD2.

The second gesture detection module 130 in practice is formed by a computer and at least one memory, separate or combined with those of the first gesture detection module 120.

Finally, the control system 10 comprises an opening element control module 140, configured to receive data originating from the first gesture detection module 120 and data originating from the second gesture detection module 130 as input.

The data originating from the first gesture detection module 120 relates to the detection or the non-detection of the predetermined gesture in the first detection area ZD1.

The data originating from the second gesture detection module 130 relates to the presence or the absence of activity in the second detection area ZD2.

The opening element control module 140 is configured to issue a command CF for closing the opening element (in this case the tailgate 11), when two predetermined conditions are met:
condition 1: the first gesture detection module 120 has detected the predetermined closing gesture, in the first detection area ZD1; and
condition 2: the second gesture detection module 130 has detected the absence of activity in the second detection area ZD2.

Preferably, in all other cases, the opening element control module 140 is configured so as not to issue a command CF for closing the opening element.

In particular, when the first gesture detection module 120 has detected the predetermined closing gesture in the first detection area ZD1, but the second gesture detection module 130 has detected the presence of activity in the second detection area ZD2, the opening element control module 140 is configured so as not to issue a command CF for closing the opening element.

The system 10 thus allows the closure of the tailgate 11 to be prevented if a movement is detected inside or over the rear trunk, even if the predetermined closing command gesture has been detected in the expected area. This thus prevents the opening element from closing on the user 3, when the user has completely unintentionally performed the predetermined gesture, while performing tasks in the vicinity of the rear trunk.

For example, when the user 3 loads and unloads luggage in the rear trunk, at the same time they quickly move to and from the rear of the vehicle. While completing these round trips, they may unintentionally perform the predetermined gesture of the foot, which gesture is normally associated with a command to close the tailgate. The invention then allows any unwanted closure of the tailgate 11 to be prevented.

This aim is achieved by simply adapting known systems that are dedicated to the detection of the predetermined gesture, thereby providing a high level of compactness.

The opening element control module 140 in practice is formed by a computer and at least one memory, separate or combined with those of the first gesture detection module 120 and of the second gesture detection module 130.

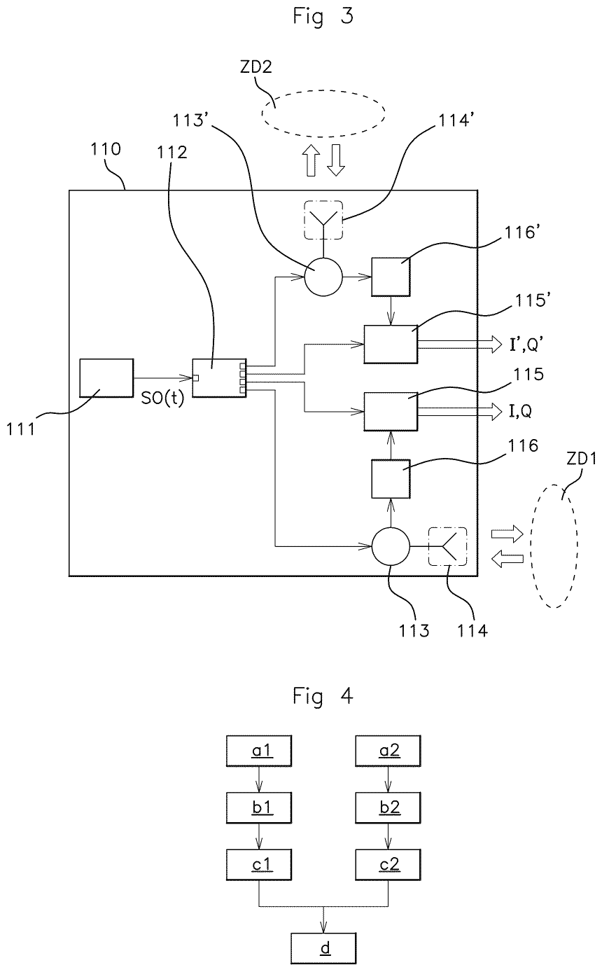

FIG. 3 is a detailed illustration of an embodiment of a transmission and reception module 110.

The transmission and reception module 110 firstly comprises an electronic oscillator 111. The electronic oscillator 111 is configured to transmit a fixed frequency source electrical signal, SO(t).

The transmission and reception module 110 then comprises at least one coupler, in this case a single coupler 112, with at least one input and at least four outputs. The coupler 112 is connected to the input of the electronic oscillator 111 so as to receive the signal SO(t) as input.

The coupler 112 divides the signal SO(t) into four portions, each guided to a respective channel from among the four output channels.

The first channel of the output channels is connected to a first circulator 113, which is connected to a first antenna module 114.

The first antenna module 114 comprises at least one radio-frequency antenna configured to transmit the first transmitted radio-frequency signal to the first detection area ZD1, and to receive the first received radio-frequency signal. The first antenna module 114 comprises at least one radio-frequency antenna, preferably a first transmit and receive antenna, which during use is oriented toward the rear of the vehicle, and a second transmit and receive antenna, which during use is oriented toward the underside of the vehicle. Many other variants can be implemented, for example, with separate antennas for signal transmission and reception.

The second channel of the output channels of the coupler 112 is connected to a first pre-processing module 115.

The first pre-processing module 115 receives the following as input:
an electrical signal at the frequency of the first transmitted radio-frequency signal originating from the coupler 112 (second output channel of the coupler); and
an electrical signal corresponding to the first received radio-frequency signal, in this case originating from the first antenna module 114, and after passing through the first circulator 113 and a first amplifier 116.

The first pre-processing module 115 comprises at least one first mixer. This first mixer is configured to carry out at least one mixing operation between the two electrical signals that it receives as input, so as to provide, as output, a signal I that results from mixing these two signals in phase, and a signal Q that results from mixing these two signals in phase opposition.

The signals I and Q are sent to the first gesture detection module as input, not shown in FIG. 3.

The third channel of the output channels is connected to a second circulator 113′, which is connected to a second antenna module 114′.

The second antenna module 114′ comprises at least one radio-frequency antenna configured to transmit the second transmitted radio-frequency signal to the second detection area ZD2, and to receive the second received radio-frequency signal. The second antenna module 114′ comprises at least one radio-frequency antenna, preferably a single antenna, which during use is oriented along the vertical gravitational axis and toward the sky, toward the rear trunk. According to other variants, two separate antennas respectively transmit and receive signals.

The fourth channel of the output channels of the coupler 112 is connected to a second pre-processing module 115′.

The second pre-processing module 115′ receives the following as input:
an electrical signal at the frequency of the second transmitted radio-frequency signal originating from the coupler 112 (fourth output channel of the coupler); and
an electrical signal corresponding to the second received radio-frequency signal, in this case originating from the second antenna module 114′, and after passing through the second circulator 113′ and a second amplifier 116′.

The second pre-processing module 115′ comprises at least one second mixer. This second mixer is configured to carry out at least one mixing operation between the two electrical signals that it receives as input, so as to provide, as output, a signal I′ resulting from mixing these two signals in phase, and a signal Q′ resulting from mixing these two signals in phase opposition.

The signals I′ and Q′ are sent to the second gesture detection module as input, not shown in FIG. 3.

The transmission and reception module 110 thus uses the same single oscillator to form both the first and second transmitted radio-frequency signals, thereby providing a high level of compactness. Furthermore, the various elements are integrated on the same integrated circuit board (PCB). In this case, the same single coupler 112 is combined in order to power the portion of the circuit that is dedicated to gesture detection in the first detection area and in order to power the portion of the circuit that is dedicated to gesture detection in the second detection area.

In variants, not shown, the transmission and reception module 110 is configured so as not to transmit the first transmitted radio-frequency signal 101₁ when the opening element is in the closed position. For example, one or more outputs of the coupler 112 can be opened or closed, in response to receiving a dedicated command. A dedicated control module receives information as input that relates to the open or closed state of the opening element, and in response provides the coupler 112 with a dedicated command. The coupler 112 and the dedicated control module then together form a switching module for distributing the source electrical signal over various channels, depending on whether the opening element is in the open or closed position. Many other solutions can be implemented to produce such a switching module.

The steps of the method implemented using the control system 10 according to the invention will now be described with reference to FIG. 4, when the vehicle 1 is stopped.

The method according to the invention comprises the following steps, implemented when the opening element is in the open position:
step a1/: transmitting, using the transmission and reception module, said first transmitted radio-frequency signal to the first detection area;
step a2/: transmitting, using the transmission and reception module, said second transmitted radio-frequency signal to the second detection area, with steps a1/and a2/being able to be implemented at least partly simultaneously;
step b1/: receiving, using the transmission and reception module, said first received radio-frequency signal, originating from the reflection of the first transmitted radio-frequency signal on a first target located in the first detection area;
step b2/: receiving, using the transmission and reception module, the second received radio-frequency signal, when said signal exists, originating from the reflection of the second transmitted radio-frequency signal on a second target located in the second detection area. Steps b1/and b2/can be implemented at least partly simultaneously. There is a second received radio-frequency signal as long as there is a target in the second detection area;
step c1/: implementing, using the first gesture detection module, first gesture detection based on Doppler shift detection and using data originating from the first received radio-frequency signal. Step c1/is used to detect when a predetermined closing gesture is performed in the first detection area ;
step c2/: implementing, using the second gesture detection module, second gesture detection based on Doppler shift detection and using data originating from the second received radio-frequency signal. Step c2/allows any activity in the second detection area to be detected, preferably a gesture or a movement performed by a human operator;
step d/: issuing, using the opening element control module, a command for closing the opening element when the predetermined closing gesture is detected in step c1/, and when the absence of a gesture is detected in step c2/. In the other cases, not issuing the command for closing the opening element. In particular, not issuing the command for closing the opening element when the predetermined closing gesture is detected in step c1/, and a gesture is detected in step c2/.

The invention is not limited to the examples described. For example, the opening element is not necessarily a tailgate, but can be a side door of a vehicle, for example.

According to other variants, the same antenna allows both the first transmitted radio-frequency signal and the second transmitted radio-frequency signal to be transmitted. The same antenna, or a separate antenna, can receive both the first received radio-frequency signal and the second received radio-frequency signal. To this end, the transmission and reception module advantageously comprises at least one element for separating radio-frequency signals that is configured to divert only a portion of an initial radio-frequency signal transmitted by the antenna, so as to separate two contributions respectively forming the first transmitted radio-frequency signal and the second transmitted radio-frequency signal.

1. A system (10) for controlling the opening and closing of an opening element (11) of a motor vehicle (1), comprising:
a transmission and reception module (110), configured to transmit a first radio-frequency signal, called first transmitted radio-frequency signal (101₁), to a first detection area (ZD1) located outside the motor vehicle during use, under and/or behind said motor vehicle, and to receive a first radio-frequency signal, called received radio-frequency signal (102₁), originating from a reflection of the first transmitted radio-frequency signal;
a first gesture detection module (120), configured to receive data originating from the transmission and reception module (110), and to implement, based on said data, the detection of at least one predetermined gesture performed in the first detection area (ZD1); and
an opening element control module (140), configured to receive data originating from the first gesture detection module (120) and to issue a command for opening, respectively for closing, the opening element (CF); characterized in that:
the transmission and reception module (110) is configured to also transmit, when the opening element is in the open position, a second radio-frequency signal, called second transmitted radio-frequency signal (101₂), to a second detection area (ZD2) separate from the first detection area, located in a rear trunk of the motor vehicle during use, and to receive a second radio-frequency signal, called second received radio-frequency signal (102₂), originating from a reflection of the second transmitted radio-frequency signal;
the system further comprises a second gesture detection module (130), configured to receive data originating from the transmission and reception module (110), and to implement, based on said data, the detection of any gesture performed in the second detection area (ZD2); and
the opening element control module (140) is configured to also receive data originating from the second gesture detection module (130), and to:
i/ issue the command for closing the opening element (CF), when the first gesture detection module (120) has detected a predetermined closing gesture in the first detection area (ZD1), while the second detection module (130) has detected the absence of a gesture in the second detection area (ZD2); and
ii/ not issue the command for closing the opening element (CF), when the first gesture detection module (120) has detected the predetermined closing gesture in the first detection area (ZD1), while the second detection module (130) has detected any gesture performed in the second detection area (ZD2).

2. The system (10) as claimed in claim 1, characterized in that the transmission and reception module (110) comprises an electronic oscillator (111), configured to generate a source electrical signal (SO(t)), and in that the transmission and reception module (110) is configured to use said source electrical signal to form both the first transmitted radio-frequency signal (101₁) and the second transmitted radio-frequency signal (101₂).

3. The system (10) as claimed in claim 2, characterized in that the transmission and reception module (110) further comprises:
at least one first antenna (114), configured to receive at least a portion of the source electrical signal as input, and to transmit the first transmitted radio-frequency signal in response; and
at least one second antenna (114′), configured to receive at least a portion of the source electrical signal as input when the opening element is in the open position, and to transmit the second transmitted radio-frequency signal in response.

4. The system (10) as claimed in claim 1, characterized in that the transmission and reception module (110) comprises at least one first mixer (115), configured to carry out mixing between an electrical signal at the frequency of the second transmitted radio-frequency signal (101₂) and an electrical signal formed by the second received radio-frequency signal (102₂), and in that the transmission and reception module (110) is configured to provide the first gesture detection module (120) with data resulting from this mixing.

5. The system (10) as claimed in claim 4, characterized in that the transmission and reception module (110) comprises at least one second mixer (115′), configured to carry out mixing between an electrical signal at the frequency of the second transmitted radio-frequency signal (101₂) and an electrical signal formed by the second received radio-frequency signal (102₂), and in that the transmission and reception module (110) is configured to provide the second gesture detection module (130) with data resulting from this mixing.

6. A motor vehicle (1) comprising at least one opening element (11) able to be closed or opened upon receiving a command (CF) for closing, respectively opening, the opening element, characterized in that it further comprises a control system (10) as claimed in claim 1.

7. A method for controlling the closing of an opening element (11) of a motor vehicle, implemented within a motor vehicle (1) comprising at least one opening element able to be closed upon receiving a closing command (CF), and using a control system (10) as claimed in claim 1, the method comprising the following steps, implemented when the opening element is in the open position:
a1/ transmitting the first transmitted radio-frequency signal (101₁) to the first detection area (ZD1) located outside the vehicle, under and/or behind said motor vehicle; and
a2/ transmitting the second transmitted radio-frequency signal (101₂) to the second detection area (ZD2) separate from the first detection area, located in a rear trunk of the motor vehicle;
b1/ receiving the first received radio-frequency signal (102₁) originating from the reflection of the first transmitted radio-frequency signal on a first target located in the first detection area (ZD1); and
b2/ receiving, the second received radio-frequency signal (102₂), when said signal exists, originating from the reflection of the second transmitted radio-frequency signal on a second target located in the second detection area (ZD2);
c1/ implementing first gesture detection, based on Doppler shift detection and using data originating from the first received radio-frequency signal (102₁); and
c2/ implementing, when a second received radio-frequency signal has been received in step b2/, second gesture detection, based on Doppler shift detection and using data originating from the second received radio-frequency signal (102₂); then
d/ issuing, when a predetermined closing gesture is detected in step c1/, and the absence of a gesture is detected in step c2/, the command (CF) for closing the opening element.

8. The method as claimed in claim 7, characterized in that the first target is a foot of a user (3), and in that the second target is a portion of an upper limb or the torso or the head of said user (3).
